(19) United States
(12) Patent Application Publication
(10) Pub. No.: US 2007/0180497 A1
(43) Pub. Date: Aug. 2, 2007

(54) Domain manager and domain device

(75) Inventors: Bogdan Costin Popescu, Amsterdam (NL); Franciscus Lucas Antonius Johannes Kamperman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,611

(22) PCT Filed: Mar. 7, 2005
(86) PCT No.: PCT/IB05/50834

§ 371 Date: Sep. 6, 2006

(30) Foreign Application Priority Data
Mar. 11, 2004 (EP) 04100997.8

(51) Int. Cl. H04L 9/32

(52) U.S. Cl. 726/4

(57) ABSTRACT

A domain manager device for managing a network. The manager issues to a new device joining the network a number of symmetric authentication keys, and preferably a number of authentication tickets. Each respective authentication key allows the new device to communicate securely with one respective other device comprised in the network. Each respective authentication ticket allows a device with a first identifier to authenticate itself to a device with a second identifier. The new device receives those authentication tickets whose first identifier matches its identifier. The new device presents the ticket with second identifier ‘B’ to device ‘B’ to authenticate itself to ‘B’. Preferably the domain manager generates a number of master device keys and issues one to the new device. Then the authentication tickets can be encrypted with the master device key issued to device with the second identifier.

In the past few years there has been an ever increasing interest in developing software/hardware architectures for digital rights management (DRM). The main purpose of such architectures is supplying digital data content (mostly home entertainment-related) in a way that is safe and secure from the content owners/providers point of view, while also acceptable from a privacy point of view and convenient for the consumers.

The biggest security threat for content owners/providers is unlimited illegal copy and distribution of their copyrighted digital content; for this reason, the focus of most DRM architectures is on mechanisms allowing owners/providers to control the way digital content is distributed and processed. A key concept for supporting this is the compliant device—a device that by its construction is guaranteed to process digital content only in ways sanctioned by the owners of the content. The most important property of compliant devices is the fact they are self-policing—before performing any operation on a piece of data content, they check that the operation does not contradict the rules set by the content owners for that piece of content. Because of this property, data exchange rules between compliant devices can be greatly simplified: for example, a compliant digital video recorder can be safely given full access to a piece of video marked “no copy”—since the recorder is compliant, the owner of the video can be assured it will never make a copy, even though it has the ability to do that.

Compliant devices normally incorporate cryptographic keys that facilitate compliance checking (proving to other devices they are indeed compliant), and are manufactured as tamper resistant to prevent their (potentially malicious) users from circumventing protection mechanisms and getting unrestricted access to copyrighted digital content.

Currently, there are two possible general approaches for doing device compliance checking: in the case of individual authentication, this is done by means of public key cryptography—by assigning each device a unique public/private key pair with the public key certified by a licensing organization through a digital certificate. In this case, whenever two compliant devices need to interact, they must first engage in a mutual authentication protocol, proving to each other they have the private keys corresponding to “compliant” public keys.

The other way to do device compliance checking is through group authentication: in this case, the identity of a given device is un-important, as long as the device can prove it is part of the group of compliant devices. In practice, the most efficient way to do group authentication is based a class of symmetric key encryption algorithms known as broadcast encryption, discussed in e.g. Jeffrey B. Lotspiech, Stefan Nusser, and Florian Pestoni. Broadcast encryption's bright future. IEEE Computer, 35(1), 2002.

The main problem with individual authentication is the fact that it relies on public key cryptographic algorithms, which are slow if implemented in software, and more expensive if implemented in hardware (the cost of dedicated hardware accelerators adds to the total price of the device). On the other hand, solutions based on broadcast encryption can be reasonably efficiently implemented in software; however they have their own problems, such as limited ability to revoke compromised devices, as well as limited support for expressing complex security policies governing the interaction between compliant devices.

In the area of digital rights management, the concept of an authorized domain has recently been introduced in standard bodies like DVB and TV-Anytime. Authorized domains try to find a solution to both serve the interests of the content owners (who want protection of their copyrights) and the content consumers (who want unrestricted use of the content). The idea is to have a controlled network environment in which content can be relatively freely used as long as it does not cross the border of the authorized domain. Typically, authorized domains are centered around the home environment.

Some design requirements for particular architectures have already been outlined in international patent application WO 03/098931 (attorney docket PHNL020455) and in F. Kamperman and W. Jonker, P. Lenoir, and B. vd Heuvel. Secure content management in authorized domains. In Proc. IBC2002, pages 467-475, September 2002. These requirements include issues such as authorized domain identification, device check-in, device check-out, rights check-in, rights check-out, content check-in, content check-out, as well as domain management. These documents assume compliance checking based on individual authentication through public key certificates; however, this is not optimal from a performance/economic point of view (public key operations are slow when implemented in software and expensive when implemented in hardware).

Reliance solely on public key cryptographic algorithms is clearly the weak point of these designs—this means that in order to allow any-to-any device communication patterns, every device part of the domain needs to include hardware cryptographic accelerators for speeding up public key operations; this clearly increases the overall cost of the system. In this document we present an alternative design, which attempts to solve this problem. In particular, we aim to mediate the following (contradicting) issues:
The architecture should support individual device authentication.
The architecture should work reasonably efficient when public key operations are executed in software (public key hardware accelerators should not be mandatory).
The architecture should support a potentially large number of revoked devices without drastic performance degradation.

### BRIEF DESCRIPTION OF THE INVENTION

It is an object of the invention to enable authentication between devices in a network which does not require the use of public key cryptography.

This object is achieved according to the invention in a domain manager device comprising authentication means for issuing to a new device joining the network a predetermined number of symmetric authentication keys, each respective authentication key allowing authenticated communication with one respective other device comprised in the network.

This object is further achieved according to the invention in a first device arranged to communicate with a second device via the network and comprising networking means for requesting to said domain manager device to join the network and for receiving said symmetric authentication keys, and authentication means for communicating with the second device using the symmetric authentication key allowing authenticated communication with the second device.

The invention combines the advantages associated with solutions based on symmetric key cryptographic algorithms—namely fast software implementation—while avoiding the major disadvantage associated with existing such solutions—namely their lack of support for individual authentication. Additionally, this architecture supports very efficient revocation mechanisms, which are a clear advantage over existing solutions.

A great advantage of the hybrid architecture according to the invention is that public key operations not needed for inter-device authentication. It may be desirable to perform public key operations when the first device requests to join the network, i.e. when the first device authenticates itself to the domain manager. However, at this point the first device is not yet part of the network. Following that authentication phase, all authentication between the devices part of the same domain is done by means of (fast) symmetric key operations.

The price we pay for this is additional storage requirements in every device; however, assuming authorized domains only contain a limited number of devices (in the order of tens), these storage requirements are not excessive.

Additionally, authentication tickets allowing a device with a first identifier to authenticate itself to a device with a second identifier can be issued as per claim 2. These can be presented by the first device to the second device. If the second device accepts the received authentication ticket as valid, the first device is authenticated.

Additionally, a predetermined number of master device keys may be generated, and a respective one of the master keys is then issued to every respective device joining the network. These keys serve as shared secrets between domain manager and individual devices, allowing each device to authenticate information purportedly from the domain manager. Furthermore, devices only need tamper-resistant memory for storing their device master key. All the other data can be stored in untrusted memory, encrypted under the master key.

Each authentication ticket for authenticating device A to device B is preferably at least partially encrypted with a master device key associated with device B. This way B can, upon receiving this ticket from A, confirm that the ticket is authentic by successfully decrypting the ticket.

The invention allows the generation of authentication keys and tickets in advance. If each master device key is assigned a unique identifier, the authentication keys and tickets can be associated with respective master device key identifiers. This means a device can be issued tickets for devices that have not yet joined the network. For example, every device joining the network can now be issued one authentication tickets for every other device that can possibly be in the network at the same time (i.e. he receives one ticket fewer than the maximum number of concurrently allowed devices in the network), even if at the time he joins there are (many) fewer devices than that on the network.

A subsequently joining device is assigned one master key and the identifier corresponding to that master key. Without any further action, every device already in the network now can authenticate itself to and communicate with that subsequently joined device by using the appropriate authentication key and ticket.

The domain manager can create a local revocation list by identifying those revoked devices on a global revocation list that are comprised in the network. To allow the devices to authenticate the local revocation list, the domain manager generates a number of revocation authentication codes, each respective revocation authentication code enabling authentication of the local revocation list using one of the master device keys. Each device can decrypt one of the revocation authentication codes using its own master device key and thereby establish the authenticity of the local revocation list.

A problem with existing solutions for revocation, such as discussed in international patent application WO 03/107588 (attorney docket PHNL020543), is that revoking a large number of devices results in significant performance penalty: in the best case, the revocation data structure size grows at least linearly to the number of revoked devices (so, a simple calculation shows that revoking 100,000 devices leads to a 1 MB revocation list). Since the revocation list needs to be stored and processed by every compliant device, this greatly increases the device memory requirements. According to the invention, only a small subset of the global device revocation list needs to be stored and processed by the devices in the network.

### BRIEF DESCRIPTION OF THE FIGURES

These and other aspects of the invention will be apparent from and elucidated with reference to the illustrative embodiments shown in the drawings, in which:

FIG. 1 schematically shows a system comprising devices interconnected via a network;

FIG. 2 schematically illustrates an AD manager and a device in more detail;

FIG. 3 shows an example on how local device identifiers (LDIs), master device keys (MDK) and global device identifiers (GDIs) can be stored.

Throughout the figures, same reference numerals indicate similar or corresponding features. Some of the features indicated in the drawings are typically implemented in software, and as such represent software entities, such as software modules or objects.

### DETAILED DESCRIPTION

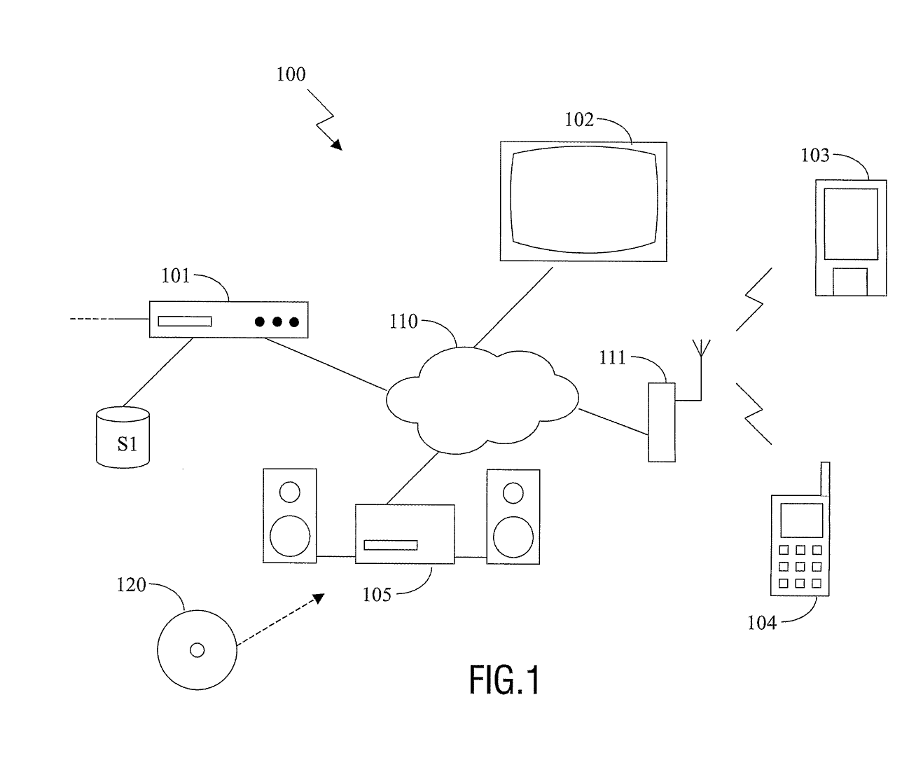

FIG. 1 schematically shows a system 100 comprising devices 101-105 interconnected via a network 110. In this embodiment, the system 100 is an in-home network that operates as an Authorized Domain. A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set top box (STB), is usually the central device, providing central control over the others.

Content, which typically comprises things like music, songs, movies, TV programs, pictures, games, books and the likes, but which also may include interactive services, is received through a residential gateway or set top box 101. Content could also enter the home via other sources, such as storage media like discs or using portable devices. The source could be a connection to a broadband cable network, an Internet connection, a satellite downlink and so on. The content can then be transferred over the network 110 to a sink for rendering. A sink can be, for instance, the television display 102, the portable display device 103, the mobile phone 104 and/or the audio playback device 105.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 101, or any other device in the system 100, may comprise a storage medium S1 such as a suitably large hard disk, allowing the recording and later playback of received content. The storage medium S1 could be a Personal Digital Recorder (PDR) of some kind, for example a DVD+RW recorder, to which the set top box 101 is connected. Content can also enter the system 100 stored on a carrier 120 such as a Compact Disc (CD) or Digital Versatile Disc (DVD).

The portable display device 103 and the mobile phone 104 are connected wirelessly to the network 110 using a base station 111, for example using Bluetooth or IEEE 802.11b. The other devices are connected using a conventional wired connection. To allow the devices 101-105 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

Generally speaking, an authorized domain comprises the following entities:
A number of digital content items. A content item is a copyrighted piece of electronic information. Each content item has an owner, who is the entity (human/institution) allowed to set the usage rules for that item.
A number of compliant devices such as devices 101-105. These are pieces of electronic equipment built by licensed manufacturers. They can be capable of rendering, storing and recording content items. By construction, compliant devices will only process data items in ways sanctioned by their owners through the usage rules. A compliant device will never process a content item before consulting the usage rules for that item.
One Authorized Domain (AD) manager device, for instance the set top box 101. This is a compliant device that keeps track of the other devices in the domain: it registers new devices entering the domain, and removes the devices leaving the domain, as well as devices that have been compromised (are known not to be compliant anymore).
A number of ContentManager devices, for instance the set top box 101 and the audio playback device 105. These are compliant devices that bring new data content into the domain. They do this either by interacting with content owners/providers, or by directly reading content from pre-packaged media (DVDs for example). We assume that at manufacture time, each compliant device is given a public/private key pair, with the private key stored in tamper-resistant memory, and the public key certified by a licensing organization by means of a device certificate. We also assume each compliant device is identified by a unique global device ID (GDI), also included in the device certificate.

It is important to understand that a device can play multiple roles: it can render content, as well as being the AD manager and possibly a Content Manager. The amount of functionality packed in a given device is a manufacturer/consumer choice. From the consumer point of view, extra functionality in a device is materialized through additional command interfaces: the AD manager device needs a special AD management interface, while the content managers need command interfaces allowing interaction with the content providers they support.

Authorized Domain Creation

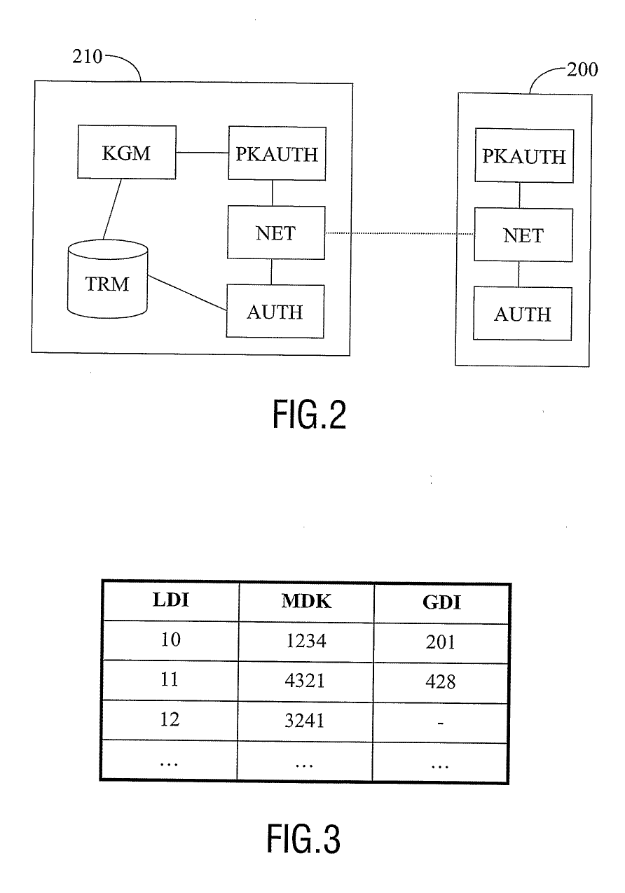

FIG. 2 schematically illustrates an AD manager 210 and a device 200 in more detail. Creating a new AD requires one compliant device with AD manager functionality. The owner of the domain uses the AD management interface to issue a “create new AD” command. When receiving such a command, the AD manager device first erases all information about the previous AD it has managed; following that it activates key generation means KGM to generate a master device key list (a list of symmetric encryption keys, preferably 128-bits AES keys) which is stored in its tamper-resistant memory TRM.

The size of this list is best chosen as equal to the maximum number of devices allowed in the domain; this is a manufacturer/content provider choice, but we expect it to be in order of tens. The size could also be chosen higher.

Finally, the manager generates a domain ID, also stored in its tamper-resistant memory TRM. The domain ID preferably is built as a concatenation of the manager's GDI and an ever-increasing domain version number. At manufacture time, the domain version number is set to zero. Whenever the AD manager is reset, the domain version number is incremented, which ensures the manager will always generate different domain IDs. Once both the master device key list and the domain ID have been generated, the AD creation process is complete, and the manager can populate the new domain by registering new devices.

Device Registration

A device 200 that enters the AD needs to be registered with the AD manager. The registration may be performed automatically when the device D attempts to join the domain, or on request. Registration involves communication over the network, to which end the device 200 and the manager 210 comprise networking modules NET.

The registration phase consists of two steps: compliance checking, and authentication. In the compliance checking step, the AD manager authenticates the new device as being certified as compliant by the licensing organization. If this step completes successfully, the AD manager adds the new device to the domain, by giving them the cryptographic material that they need to interact with other devices in the domain.

Compliance Checking Protocol

The first step in registering a new device to a domain is compliance checking. Compliance checking is done by means of public key cryptography. The AD manager and the new device then engage in a public-key mutual authentication protocol that also allows secret key transport (examples of such protocols are described in ISO/IEC 11770-3, 1999). To this end both comprise public key authentication modules PKAUTH.

At the end of the protocol, each device is assured the other one has access to a private key corresponding to a public key certified as “compliant” by the licensing organization. Once this is done, the AD manager 210 assigns (through a key transport protocol) the registering device 200 a device master key from its device master key list. The index of this key in the manager's list becomes the local device ID (LDI) for the newly registered device. It is assumed the domain manager stores the GDI of each registered device, as well as the LDI associated with that GDI. This is required for device registration.

In FIG. 3 an example is shown on how local device identifiers (LDIs), master device keys (MDK) and global device identifiers (GDIs) can be stored in the tamper-resistant memory TRM. For example, LDI “10” is associated with MDK “1234” and assigned to device with GDI “201”. LDI “12” is associated with MDK “3241” but not assigned to any device (yet).

Device Authentication

Accepting a device in an AD requires allowing the device to authenticate to other devices in the AD in order to obtain content items. The AD manager comprises an authentication module AUTH that issues the new device an authentication credentials set consisting of a number of (authentication key, authentication ticket) pairs.

When a device has registered, it is assigned a local device identifier, say A, and given the master key associated with that local device identifier MK_{A}. The AD manager also generates for the device now known as A an authentication credentials set consisting of a number of authentication keys and authentication tickets, preferably as respective pairs of the form (K_{AY}, authenticationTicket_{AY}), with Y ranging from 0 to N (N being the number of master keys) and Y not equal to A.

Authentication key K_{AB} allows device A to encrypt communication to a device with local device identifier B. It is worth noting that no device with LDI B might be present in the network when A registers. In such a case, when another device joins the network, it can be assigned LDI B and then A will be able to communicate with it using key K_{AB}. Preferably the authentication keys are symmetric encryption keys, i.e. usable with symmetric encryption schemes (also known as secret-key encryption schemes). It is possible to choose corresponding keys as equal, i.e. K_{AB}=K_{BA}. This however implies the device manager needs to remember all possible pairwise keys between devices—so the storage requirements grow quadratic to the domain size. By choosing K_{AB} different from K_{BA}, the manager can generate these keys on the fly, place them in the authentication tickets, and then forget about it. Each device is given authentication keys for every other device already part of the domain as well as for all potential devices that may join the AD in the future.

In one embodiment the number of authentication keys given to each device is chosen as equal to the size of the master key list generated by the manager when creating the AD. In this way, when new devices join the AD, existing devices need not be updated, which allows the AD to operate even without assuming continuous network connectivity among its individual components.

There is an authentication ticket associated with each authentication key. The authentication ticket allows a device A to authenticate itself to a device with local device identifier B. Again, no device with LDI B might be present in the network when A registers. Still, as local device identifiers are assigned by the AD manager, it is possible to create tickets referencing LDI B even when that LDI is not in use.

Preferably the ticket has the form (ID_{Domain}, K_{AB}, GDI_{A}, LDI_{source}, LDI_{destination}), where ID_{Domain} is the domain identifier, GDI_{A} is A's global device ID, LDI_{source} is the local device ID of the source device (here A) and LDI_{destination} is the local device ID of the destination device (here B). The ticket can be used by A to prove to B that A is a compliant device part of the same domain. Tickets may carry an expiry date and/or a version number. This allows devices to reject outdated tickets.

The ticket for device A preferably contains the GDI of that device A. This allows a device receiving this ticket to learn A's GDI. The GDI is needed to verify whether A has been revoked, for instance by checking for A's GDI on a global revocation list or by checking for that GDI on the local ticket revocation list (see below).

The ticket is preferably encrypted using the master device key for B, K_{B}. Since the ticket is encrypted with a key shared only between B and the manager, B is assured only the manager could have created it, which in turn (given the manager is a compliant device following the protocol) implies the manager has verified the compliance of A. Other ways to protect the authenticity of the ticket may also be used. This even applies if no device with LDI B is present in the network when the AD manager issues this ticket to A. Once a device is assigned LDI B, it will also receive a copy of the master device key associated with this LDI and so will be able to verify the authenticity of tickets presented to it.

Once a device is part of the domain, it can be used to process the content items it acquires from other devices in the domain. Before exchanging content items, two devices authenticate each other in order to prove they are part of the same domain. The device 200 is provided with authentication module AUTH to perform this function, as shown in FIG. 2. The authentication protocol between the two devices is as follows. It is described in detail in B. Crispo, B. C. Popescu, and A. S. Tanenbaum. Symmetric key authentication services revisited. Technical Report IR-CS-005, Vrije Universiteit, 2003.
(1) A→B: LDI_{A}, N_{A}
(2) B→A: LDI_{B}, N_{B}, authenticationTicket_{BA}
(3) A→B: <N_{B}>SK, authenticationTicket_{AB}
(4) B→A: <N_{A}>SK
   In the above protocol, N_{A} and N_{B} are challenges (nonces) chosen by A and B respectively.

At the end of Step 2, device A gets authenticationTicket_{BA}, which is encrypted under K_{A} (the master key assigned to that device), which allows A to decrypt the ticket and get K_{BA}. Now device A has both K_{AB} and K_{BA}, so it can compute SK=SHA-1 (K_{AB}, K_{BA}, N_{A}, N_{B}) and encrypt N_{B} with it.

At the end of step (3), device B gets authenticationTicket_{AB}, which it can decrypt to get K_{AB}. With both K_{AB} and K_{BA} device B can also compute SK. With SK, device B can verify that device A has correctly encrypted N_{B} (this authenticates A to B) and then it can encrypt N_{A}, and send it to device A in step (4). Device A can decrypt<N_{A}>SK and thereby authenticate B to A.

At the end of the protocol SK is the shared secret between A and B and can be used for securing the data traffic between the two devices. The notation <X>K indicates element X is encrypted using key K. SHA-1 is the well-known FIPS 180-1 secure hash function and is the preferred choice for computing SK.

During the authentication protocol, before accepting the other party's ticket, a device B needs to do the following checks:
The ID_{Domain} in the ticket corresponds to the authorized domain the device is part of.
The LDI_{destination} in the ticket is equal to its own LDI_{B}.
The other device has not been revoked (discussed below)
   Secure Content Storage

Data content items are brought in the domain by the content manager devices. They bring this content either by interacting with external content providers, or by reading the content from pre-packaged media (e.g. DVDs). Data items should be stored in un-encrypted form only in tamper-resistant memory. Given the fact that tamper-resistant memory is considerably more expensive than untrusted storage, we employ a two level scheme: once it obtains a piece of data content, a content manager generates a random content key (for example a 128-bits AES key), and encrypts the content with that key. Following that, it encrypts the content key with its master key. The encrypted content and the encrypted content key can then be safely stored on an unsecure storage medium such as a local hard disk, a (re)writable DVD or even on a network drive. Whenever the device needs the content, it can read the encrypted content and the encrypted content key into its tamper resistant memory, use its master device key to decrypt the content key, and use the content key to decrypt the actual content.

The same optimization can be used to improve the performance of content transfer between devices. Assuming two devices A and B part of the same domain, the protocol for securely transferring content from A to B is as follows:
A and B authenticate each other as part of the same domain and establish a secure communication channel.
A transfers the encrypted content to B over an insecure channel (this is safe since the content is encrypted with the content key).
A transfers the content key to B over the secure channel.
B encrypts the content key with its master device key, and stores it (together with the encrypted content) on its un-secure storage for later use.
   Device Revocation

There are three cases in which a device ceases to be part of a domain: when the device is voluntarily removed from the domain (e.g. because it is moved to another domain), when the device is no longer functional, and finally when the device is known to be no longer compliant (device revocation). The last case is discussed here.

Devices known to be no longer compliant are revoked by the licensing organization. The mechanisms by which such devices are identified are beyond the scope of this report, but they would most likely involve forensic examination of illegal devices sold on the black market (illegal devices that would incorporate cryptographic material extracted from compromised compliant devices). In any case, the licensing organization publishes the GDIs of these compromised devices through a global device revocation list (GDRL).

Device revocation lists are distributed by content providers together with the data content items; because they list revocation information regarding all compliant devices in the world, we assume device revocation lists can be quite large (if we have 1 billion compliant devices, out of which only 1% are compromised, the size of the revocation list would be in the order of 40 MB). Because of this, we cannot assume that all devices have enough memory/computational power to process the global revocation list.

Since revocation information is bundled with content, it follows that it is the content manager devices that bring this information into the domain. We require that all content managers are capable of processing revocation information; when a content manager receives a new GDRL, it does the following:
It verifies that its domain manager is not revoked. If the domain manager is revoked, the domain is no longer compliant (since it cannot be assumed anymore that the AD manager does the compliance check properly). In this case, the content manager should refuse to introduce any more content into the domain.
If the AD manager is not revoked, the content manager attempts to connect to it.
If the AD manager is reachable, the content manager forwards it the GDRL. The AD manager processes the GDRL, and returns a Ticket Revocation List (TRL) discussed below. The TRL is then bundled with the data content; once a TRL is attached to a piece of data content that content supports unrestricted distribution.
If the AD manager is not reachable, the content manager keeps the original GDRL attached to the data content. However, in this case the data content supports only restricted distribution.
   It is important to understand that a TRL is only meaningful for devices part of the domain whose manager has issued that TRL. Should a piece of data content have to be exported to other domains, it should be the GDRL and not the TRL that is attached to that content.
   Generating the Ticket Revocation List

The AD manager is responsible for generating the ticket revocation list (TRL). The AD manager has a list of the GDIs of the devices presently in the domain. This means the AD manager can check for all these GDIs whether they occur on the GDRL and thereby create a list of the GDIs of domain devices that have been revoked (they are present in the GDRL). This list is the TRL. Since the total number of devices in a domain is at most in the order of hundreds, we expect the TRL to be much smaller than the GDRL.

It should be possible for every device in the domain to authenticate a TRL as produced by the AD manager. To accomplish this, the AD manager creates one TRL authentication code for each local device identifier (i.e. for each device and potential device in the domain) which can be authenticated using the master device key associated with that particular local device identifier.

In the preferred embodiment, for LDI I the TRL authentication code is the keyed message authentication code (HMAC) as defined in Internet RFC 2104 of the TRL using the master device key K_{I}, preferably using the SHA-1 cryptographic hash function. The TRL then consists of the actual list of revoked devices plus the authentication codes for all keys in the master key list.

When a device receives a piece of data content marked as unrestricted distribution, it first checks the authenticity of the TRL associated with that content. This is done by first finding the TRL authentication code corresponding to its LDI, then computing the HMAC using its own device master key and then verifying that the authentication code is identical to the computed HMAC of the list.

Unrestricted Distribution

Content items that support unrestricted distribution can be exchanged between any two compliant devices part of the domain. Considering two compliant devices A and B, the rules for content exchange are as follows (we assume A is the content source and B is the destination):
A and B authenticate each other, using the authentication protocol described earlier. The shared key resulted at the end of the authentication protocol is then used to secure the rest of their data exchange.
A verifies that GDI_{B} is not in the TRL. If B is revoked, A will not pass it the content.
A sends to B the content item, together with the TRL and the access rules associated with the content.
B verifies the authenticity of the TRL (as described earlier). If everything is OK, B can now further distribute the content to other compliant devices (following the content access rules of course).
   Restricted Distribution

Content items that support restricted distribution can only be exchanged when the source device is capable of processing the GDRL associated with the item. Considering two compliant devices A and B, the rules for content exchange are as follows (we assume A is the content source and B is the destination):
A needs to be a compliant device capable of processing GDRLs.
A and B authenticate each other, using the authentication protocol described earlier. The shared key resulted at the end of the authentication protocol is then used to secure the rest of their data exchange.
A verifies that B's GDI (listed in B's authentication ticket) is not in the GDRL. If B is revoked, A will not pass it the content.
A sends to B the content item, together with the GDRL and the access rules associated with the content.
If B is capable of processing GDRLs, it verifies the authenticity of the GDRL by verifying the signature of the licensing organization. Otherwise, B is not allowed to further distribute the content item to other devices in the domain.

Devices that hold copies of content marked “restricted distribution” may attempt to convert it to “unrestricted distribution” by contacting the AD manager in order to obtain the TRL for that content. Once they succeed, they replace the GDRL associated with the content with the TRL, and mark the content as “unrestricted”.

Key Update

If too many devices are removed from the domain, the domain manager may eventually run out of master keys to assign to new devices. One solution to this problem is to terminate the domain and re-start with a new master device key list. From the consumer's point of view, this is clearly not acceptable.

A more acceptable option is to re-use the LDIs of removed devices. Consider a device A, with LDI_{A}=11. When A ceases to be part of the domain, its GDI is added to the domain's TRL, and A's device master key is replaced with a fresh key in the manager's master key list. In the table of FIG. 3, this can be done simply by overwriting the MDK “4321” with the new MDK. This new key is then assigned to a future device joining the domain (assume this is C). In this way, C is now assigned the LDI previously assigned to A (LDI_{C}=11). As in the normal device registration protocol, the manager gives C an authentication credentials set for all the other master keys in its master key list.

If the tickets are encrypted with the master device keys, a problem now is that all the other devices in the domain have tickets encrypted with A's old master key instead of C's key, and these tickets need to be updated. This could be done e.g. by having the domain manager transmit the updated tickets to all devices (e.g. as a network broadcast message) or have the devices periodically poll the domain manager for updated tickets.

However, it is possible to use C itself to do this update, by giving it these replacement tickets encrypted under the master keys of the devices that need the updates. To this end, the AD manager must detect that the LDI for C was previously assigned to A. The AD manager now issues a set of replacement authentication tickets to C. These replacement tickets are at least partially encrypted with C's master device key as usual for authentication tickets. With the replacement tickets other devices can authenticate themselves to C. Additionally, each replacement ticket is at least partially encrypted with the master device key of the device which can use it to authenticate itself to C.

In the authentication protocol, device B forwards C its (old) ticket allowing authentication of B to A, since C is reusing A's LDI and so B cannot distinguish C from A. C attempts to decrypt and thereby authenticate the ticket, but since the ticket is encrypted with A's old master key, the operation fails. C now recognizes that B has not been updated, and forwards it an updated ticket allowing B to authenticate itself to C.

B decrypts the replacement ticket using its master device key, and so knows the replacement ticket is authentic. B then replaces the corresponding entry in its ticket set with the replacement ticket.

Also, the key K_{BA} needs to be updated with the key K_{BC}. To do this, both K_{BC} and the authenticationTicket_{BC} can be encrypted with K_{B} so they can be safely transmitted to B.

In a preferred embodiment, the authentication protocol now operates as follows:
(1) C→B: LDI_{C}, N_{C}
(2) B→C: LDI_{B}, N_{B}, authenticationTicket_{BA}
(3) C→B: <K_{BC}, authenticationTicket_{BC}>K_{B}, <N_{B}>SK, authenticationTicket_{CB}
(4) B→C: <N_{C}>SK, authenticationTicket_{BC}
   The first two steps are equal to the normal protocol. After C detects that B has sent it an old ticket, it sends in step (3) to B the updated K_{BC} and authenticationTicket_{BC} both encrypted with B's master device key K_{B}. C also sends, as usual, the challenge N_{B} encrypted with SK (computed as above) and its authenticationTicket_{CB}. In step (4), B uses the key SK to encrypt C's challenge, which it sends back to C together with its new authentication ticket. This completes the authentication.
   Domain Marriage and Divorce

We define authorized domain “marriage” as two authorized domains joining together. Similarly, authorized domain “divorce” happens when a domain splits into two separate domains. In the case of marriage, our solution is to have all devices in one domain join (one by one) the other domain. Of course, it is expected that the total number of devices in the newly formed domain is below the maximum acceptable value. The advantage of this solution is that only devices from the second domain need to be updated. Devices in the first domain have all the key material/authentication tickets necessary to interact with the newly joining devices.

In the case of divorce, the scenario is that one authorized domain consisting of a set S of devices is split into two disjoint subsets U and V, such that S=U+V. One of the newly created domains (U for example), can simply keep all the authentication key material from the original domain S. The only thing that needs to be done in U's case is to revoke all devices in V.

In the case of V, in order to form a new domain, at least one of the devices in V needs to have domain manager functionality. Once one device in V is selected and initialised as domain manager, the other devices can simply register with it using the device registration procedure outlined earlier in this section.

It should be noted that the above-mentioned embodiments illustrate rather than limit the invention, and that those skilled in the art will be able to design many alternative embodiments without departing from the scope of the appended claims. The system 100, representing a home network, is of course not the only situation in which authorized domains are useful.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1-21. (canceled)

22. A domain manager device for managing a network including a plurality of devices, comprising:
authentication means for generating a predetermined number of authentication tickets, each respective authentication ticket allowing a device with a first identifier to authenticate itself to a device with a second identifier and for issuing to a new device joining the network a predetermined number of symmetric authentication keys, each respective authentication key allowing authenticated communication with one respective other device in the network, the authentication tickets with a first identifier matching an identifier for the new device; and
key management means for generating a predetermined number of master device keys, the authentication means being arranged for issuing one of the generated master device keys to the new device, the key management means being arranged for associating each generated master device key with a mutually unique identifier, for assigning to the new device as a device identifier the unique identifier associated with the master device key issued to the new device, and upon the new device ceasing to be part of the network, for generating a new master device key and associating the generated new master device key with the unique identifier assigned previously as the device identifier to the new device.

23. The device of claim 22, wherein each respective authentication ticket is at least partially encrypted with a master device key from the predetermined number that is associated with the second identifier.

24. The device of claim 22, wherein the authentication means is arranged for, upon the key management means detecting that the device identifier assigned to the new device was previously assigned to another device, issuing a set of replacement authentication tickets to the new device, each respective replacement authentication ticket allowing a device with a first identifier to authenticate itself to the new device and being at least partially encrypted with the master device key associated with the first identifier.

25. The device of claim 22, wherein the key management means is arranged for receiving a global revocation list identifying a number of revoked devices, creating a local revocation list identifying those revoked devices that are comprised in the network, and generating a number of revocation authentication codes, each respective revocation authentication code enabling authentication of the local revocation list using a respective master device key from the generated predetermined number of master device keys.

26. The device of claim 25, wherein the key management means is arranged for generating each respective revocation authentication code by computing a respective keyed message authentication code of the local revocation list using each respective master device key.

27. The device of claim 22, wherein the predetermined number of authentication keys is chosen as one less than or as equal to or more than a maximum number of devices that may concurrently be comprised in the network.

28. The device of claim 22, wherein the number of master device keys in the set is chosen as equal to or more than a maximum number of devices that may concurrently be comprised in the network.

29. The device of claim 22, wherein the authentication means is arranged for generating for a particular identifier associated with a particular generated master device key a number of authentication tickets, each generated authentication ticket allowing a device with said particular identifier to authenticate itself to a device with one other of the unique identifiers associated with one of the generated master device keys.

30. A first device arranged to communicate with a second device via a network comprising a plurality of devices, the first device comprising:
networking means for requesting to a domain manager device to join the network and for receiving from the domain manager device a predetermined number of symmetric authentication keys, each respective authentication key allowing authenticated communication with one respective other device comprised in the network, a master device key and a set of authentication tickets, each respective ticket allowing the first device to authenticate itself to a respective device from the plurality of devices;
authentication means for communicating with the second device using the symmetric authentication key allowing authenticated communication with the second device, the authentication means being arranged to accept the received further authentication ticket as valid if the received further authentication ticket can be successfully decrypted using the master device key, and the authentication means being arranged for distributing to the second device the authentication ticket from the set allowing the first device to authenticate itself to the second device.

31. The first device of claim 30, wherein the networking means is arranged for receiving from the second device a further authentication ticket, and the authentication means is arranged to authenticate the second device upon accepting the received further authentication ticket as valid.

32. The first device of claim 30, wherein the authentication means is arranged for deriving a session key from information contained in the distributed ticket and in the received further authentication ticket.

33. The first device of claim 30, wherein the further authentication ticket is encrypted, and the authentication means is arranged to, upon failing to decrypt the further authentication ticket with the master device key, distribute to the second device a new authentication ticket allowing the second device to authenticate itself to the first device, the new authentication ticket being at least partially encrypted with the master device key of the second device.

34. The first device of claim 30, wherein the authentication means is arranged for receiving from the second device a new ticket allowing the first device to authenticate itself to the second device, the new ticket being at least partially encrypted with the master device key of the first device, and for decrypting the new ticket with the master device key and for replacing the ticket from the set allowing the first device to authenticate itself to the second device by the new ticket upon successful decryption of the new ticket.

35. The first device of claim 30, wherein the networking means is arranged for receiving a local revocation list identifying revoked devices that are comprised in the network and a number of revocation authentication codes, each respective revocation authentication code enabling authentication of the local revocation list using a respective master device key, the authentication means being arranged for accepting the local revocation list as valid if one of the received revocation authentication codes can be successfully decrypted using the master device key.
